(19) United States
(12) Patent Application Publication
(10) Pub. No.: US 2025/0137278 A1
(43) Pub. Date: May 1, 2025

(54) YARD STAKE WITH INTEGRATED DRIVER

(71) Applicant: John Schutte, Canton, SD (US)

(72) Inventor: John Schutte, Canton, SD (US)

(21) Appl. No.: 18/932,279

(22) Filed: Oct. 30, 2024

Related U.S. Application Data
(60) Provisional application No. 63/594,206, filed on Oct. 30, 2023.

(51) Int. Cl. E04H 12/22; B25D 1/16

(52) U.S. Cl. CPC E04H 12/22; B25D 1/16

(57) ABSTRACT

A yard stake, having a rod, a first and second stopper, and a driver. The rod has a first end and a second end opposite the first end. The first end includes a frame configured to receive an external object. The stopper is disposed on the rod. The driver is slidably disposed around the rod between the first and second stopper. The driver has a length and the rod has a length between the first and second stopper. The length of the driver is less than the length of the rod between the first and second stopper.

### RELATED APPLICATIONS

This disclosure claims priority to U.S. provisional patent application 63/594,206, filed on Oct. 30, 2023, the entire contents of which are hereby incorporated by reference.

### FIELD

The various embodiments herein relate to yard stakes.

### BACKGROUND

Outdoor spaces can be decorated in many different ways. For example, people can choose to hang up flowers, birdfeeders, signs, lights, and/or other accessories or decorations. In order to hang up these accessories, various structures can be incorporated into outdoor spaces of varying terrain. Sometimes, various hooks can be used in the decorating process.

Sometimes, the terrain can make it difficult for a user to install such a structure. The ground can be tough or difficult to break through. This can require a user to exert force, which can cause strain and/or injuries. This can be particularly tiring or increase the risk of injury if a user needs to install multiple structures.

### SUMMARY

In general, the disclosure relates to apparatuses and methods for the installation of yard stakes. Yard stakes can include features to facilitate the installation, removal, and/or positioning of the yard stake. The yard stakes can include a driver that a user can manipulate to install and/or remove a yard stake. The driver can be disposed on a rod of the yard stake between two stoppers, which can limit the movement of the driver. During use, a user can move the driver to apply an upward and/or downward force on the yard stake. This can include causing the driver to contact at least one of the stoppers.

Apparatuses and methods described herein can facilitate the installation, removal, and/or positioning of a yard stake. Use of the driver can reduce strain on a user installing a yard stake, as it can reduce the amount of force needed to move the yard stake into and/or out of a surface. Additionally or alternatively, the yard stake can include additional mounting features that can mitigate the need to insert the stake into a surface.

One embodiment includes a yard stake including a rod, a first stopper, a second stoper, and a driver. The rod includes a first end and a second end opposite the first end. The first end includes a frame configured to receive an external object. The first stopper and second stopper are disposed on the rod. The driver is slidably disposed around the rod between the first stopper and the second stopper, the driver comprising a driver length. The rod comprises a rod length between the first and second stoppers and the driver length is less than the rod length.

In a further embodiment of the yard stake, the second stopper comprises a base. The base extends perpendicularly from the rod and is configured to stabilize the yard stake.

In a further embodiment of the yard stake, the driver comprises a slide hammer.

In a further embodiment of the yard stake, the frame comprises a hook.

In a further embodiment of the yard stake, the frame comprises a U-shaped structure.

In a further embodiment of the yard stake, the frame comprises two hooks.

In a further embodiment of the yard stake, the frame comprises a coil.

In a further embodiment of the yard stake, the yard stake includes a base configured to stabilize the yard stake, wherein the base is separate from the second stopper. The base comprises a spade.

In a further embodiment of the yard stake, the second end of the rod comprises a pointed end.

In a further embodiment of the yard stake, the driver comprises one or more handles.

Another embodiment of a yard stake includes a rod, a stopper, a driver, and a stabilizer. The rod comprises a first end and a second end opposite the first end. The first end comprises a slot. The stopper is disposed on the rod. The driver is disposed below the stopper. The stabilizer is disposed at the second end of the rod. The driver is slidably disposed around the rod and between the stabilizer and the stopper.

In a further embodiment of the yard stake, the yard stake includes a hanging panel insertable into the slot.

In a further embodiment of the yard stake, the yard stake includes a mounting bracket.

In a further embodiment of the yard stake, the mounting bracket is configured to mount the yard stake to a brick.

An embodiment of a method of positioning a yard stake includes providing a yard stake and applying a force to at least one of the first or second stopper by slidably moving the driver between the first stopper and second stopper such that the driver contacts at least one of the first and second stopper. The yard stake can include a rod, a first stopper and a second stopper disposed on the rod, and a driver. The rod includes a first end and a second end opposite the first end. The first end includes a frame configured to receive an external object. The driver is slidably disposed around the rod between the first stopper and the second stopper. The driver comprises a driver length and the rod comprises a rod length between the first and second stoppers. The driver length is less than the rod length.

In a further embodiment of the method, the yard stake comprises a mount, and the method further comprises positioning the mount over a mounting surface.

In a further embodiment of the method, applying a force to at least one of the first or second stopper by slidably moving the driver between the first stopper and second stopper such that the driver contacts at least one of the first and second stopper comprises applying a greater force to the second stopper than to the first stopper, thereby positioning the yard stake at a location.

In a further embodiment of the method, applying a force to at least one of the first or second stopper by slidably moving the driver between the first stopper and second stopper such that the driver contacts at least one of the first and second stopper comprises applying a greater force to the first stopper than to the second stopper, thereby removing the yard stake at a location.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

The following drawings are illustrative of particular examples of the present invention and therefore do not limit the scope of the invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1A is a perspective view of an embodiment of a yard stake, in accordance with the systems and techniques described herein.

FIG. 1B is a perspective view of an embodiment of a yard stake, in accordance with the systems and techniques described herein.

FIG. 2A is a close-up perspective view of an embodiment of a first end structure of a yard stake, in accordance with the systems and techniques described herein.

FIG. 2B is a close-up perspective view of an embodiment of a first end structure of a yard stake, in accordance with the systems and techniques described herein.

FIG. 2C is a close-up side view of an embodiment of a first end structure of a yard stake, in accordance with the systems and techniques described herein.

FIG. 2D is a close-up side view of an embodiment of a yard stake frame, in accordance with the systems and techniques described herein.

FIG. 3 is a top-down perspective view of an embodiment of the base structure of a yard stake, in accordance with the systems and techniques described herein.

FIG. 4A is a close-up perspective view of an embodiment of the second protruding structure, in accordance with the systems and techniques described herein.

FIG. 4B is a close-up perspective view of an embodiment of the second protruding structure, in accordance with the systems and techniques described herein.

FIG. 5A is close-up perspective view of an embodiment of the first protruding structure of a yard stake, in accordance with the systems and techniques described herein.

FIG. 5B is close-up perspective view of an embodiment of the first protruding structure of a yard stake, in accordance with the systems and techniques described herein.

FIG. 6 is a close-up perspective view of an embodiment of a yard stake including a light, in accordance with the systems and techniques described herein.

FIG. 7A is a perspective view of an embodiment of a signpost, in accordance with the systems and techniques described herein.

FIG. 7B is a front view of an embodiment of a signpost, in accordance with the systems and techniques described herein.

FIG. 8A is a perspective view of an embodiment of a signpost rod, in accordance with the systems and techniques described herein.

FIG. 8B is a cross-sectional view of a signpost rod along line A-A of FIG. 8A, in accordance with the systems and techniques described herein.

FIG. 9A is a perspective view of an embodiment of a driver of a signpost, in accordance with the systems and techniques described herein.

FIG. 9B is a top view of an embodiment of a driver of a signpost, in accordance with the systems and techniques described herein.

FIG. 10A is a side view of an embodiment of a signpost panel, in accordance with the systems and techniques described herein.

FIG. 10B is a side view of an embodiment of a signpost panel, in accordance with the systems and techniques described herein.

FIG. 11 is a perspective view of an embodiment of a spade of a yard stake, in accordance with the systems and techniques described herein.

FIG. 12 is an embodiment of a stopper of a yard stake, in accordance with the systems and techniques described herein.

FIG. 13A is a perspective view of an embodiment for a mount of a yard stake, in accordance with the systems and techniques described herein.

FIG. 13B is a side view of an embodiment of a mount for a yard stake, in accordance with the systems and techniques described herein.

FIG. 14 is a block diagram of an embodiment of a method of using a yard stake, in accordance with the systems and techniques described herein.

### DETAILED DESCRIPTION

The description herein is directed to yard stakes and/or structures for yard accessories. In particular, the embodiments herein are directed to a shepherd's hook including various structural features used to assist in installation of said shepherd's hook.

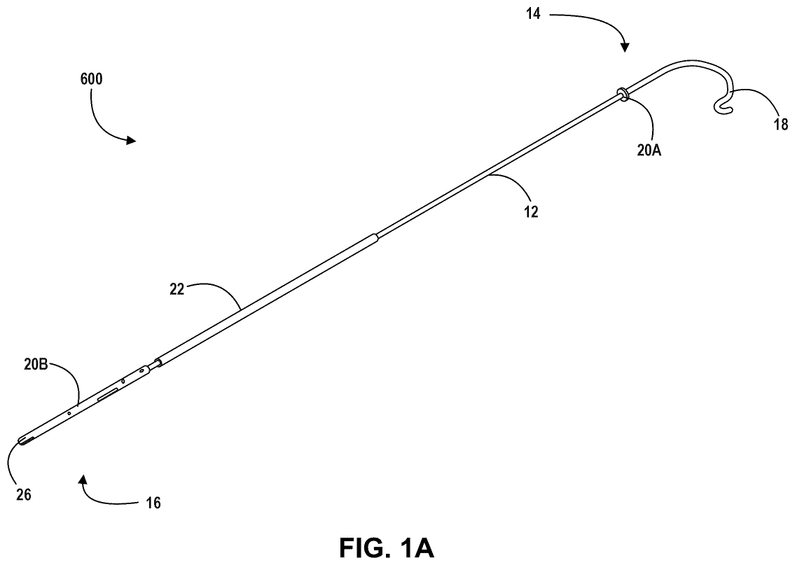

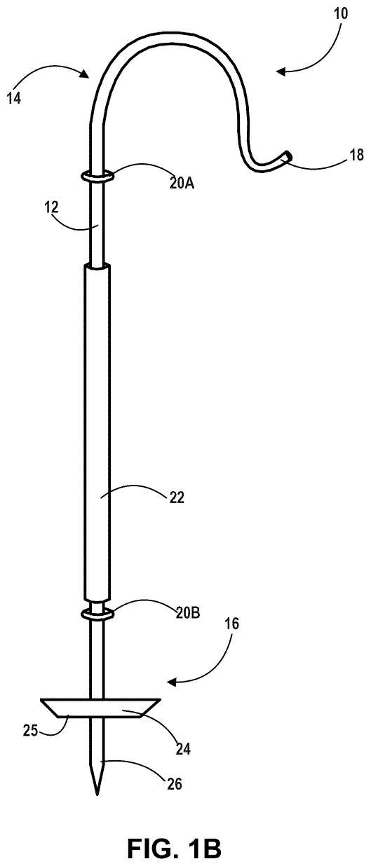

FIG. 1A shows a yard stake 600. The yard stake 600 can include a rod 12 having a first end 14 and a second end 16. The rod 12 can include a first and second stopper 20A, 20B. The first end 14 can include a first stopper 20A and a structure 18. The structure 18 can be configured to receive or mount an object. In some examples, the structure 18 can be a hook.

The second end 16 can include additional features. For example, the second end 16 can include a stopper 20B. The second end 16 can include a solid hollow pipe. The rod 12 may be solid and can be welded to the hollow pipe 26 at the second end 16. The welded portion can include about 3 inches of welded material. In some applications, the stopper 20B may be the welded portion of the rod 12. The hollow pipe 26 can be shaped to facilitate insertion of the yard stake 600 into a surface. The hollow pipe 26 can be pointed and/or curved.

A driver 22 can be slidably disposed on the rod 12 between the first and second stopper 20A, 20B. The driver 22 can be moved within the distance between the first and second stopper 20A, 20B. Each of the stoppers 20A, 20B can prevent movement of the driver 22 beyond the stopper 20A, 20B. During use, the driver 22 can be moved to insert the yard stake 600 into a surface. The driver 22 can be used to apply a force to the yard stake 600 to move the yard stake 600. Use of the driver 22 can include contacting the driver 22 with at least one of the stoppers 20A, 20B.

FIG. 1B shows an exemplary yard stake 10. The yard stake 10 can include a rod 12 comprising a first end 14 and a second end 16 opposite the first end 14. The first end 14 can include a structure 18 configured to receive an object. The yard stake 10 can include a first protruding structure 20A and a second protruding structure 20B (also referred to herein as a stopper). The protruding structures 20A, 20B can be disposed on the rod 12. The first protruding structure 20A can be disposed adjacent the first end 14 of the rod 12. The second protruding structure 20B can be disposed adjacent the second end 16 of the rod 12.

The yard stake 10 can include additional features. For example, the yard stake 10 includes a driver 22 slidably disposed on between the first protruding structure 20A and the second protruding structure 20B. The driver 22 has a driver length and a driver diameter. The rod 12 includes a rod diameter and a rod length between the first and second protruding structures 20A, 20B. The driver length is less than the rod length. In some embodiments, the length of the rod 12 can range from about 4′ to about 12′. In other embodiments, the rod 12 length can be 10′. In some embodiments, the diameter of the rod can range from ½″ to 1″. In other embodiments, the diameter of the rod can be ½″. In some embodiments, the driver length can be about 1′ to about 7′. In other embodiments, the driver length can be 4′.

The driver 22 can include a variety of features. The driver 22 can be a hollow rod. The diameter of the hollow rod can be larger than the diameter of the rod. The first and second protruding structures 20A, 20B can protrude a length from the rod. The length, or diameter, of each protrusion 20A, 20B can be more than the diameter of the driver 22. This can prevent the driver 22 from moving past the first and second protrusions 20A, 20B. The driver 22 can be made of the same material as the yard stake 10.

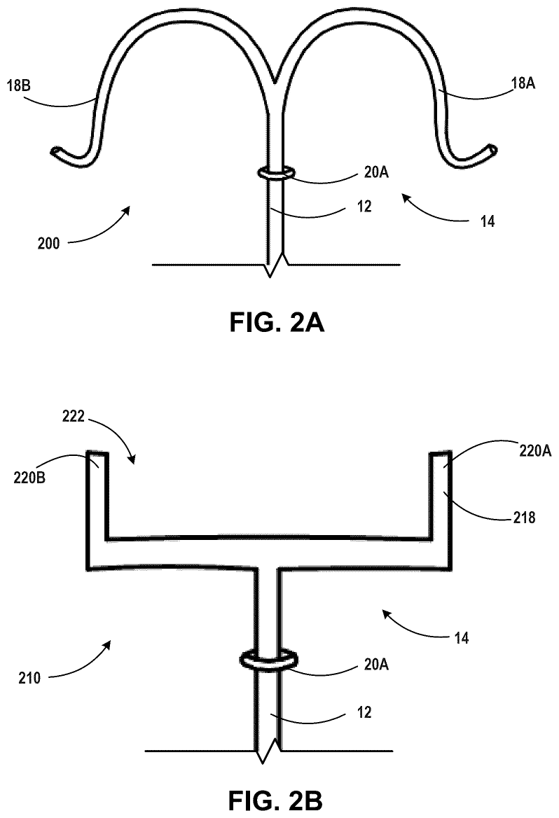

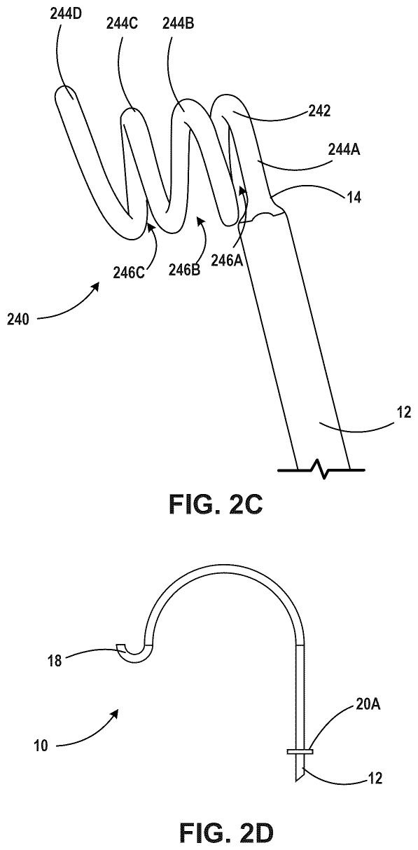

The first end 14 of the rod 12 can form several different shapes. In some examples, the structure 18 at the first end 14 of the rod 12 can curve into a shepherd's hook 18. In some applications, the hook 18 can be used to hang plants, signs, birdfeeders, and other yard accessories. Various features of the yard stake 10 can accommodate for weight of objects disposed on the hook 18. For example, the driver 22 can stabilize the rod 12 by preventing deformation of the rod 12 that could be caused by the weight of an object hung on the hook 18. FIG. 2A and FIG. 2B show various configurations of the structure 18.

FIG. 2A shows a shepherd's hook 200 including multiple hooks 18A, 18B. Multiple hooks 18 can be used to hang multiple objects. In some examples, the hooks 18A, 18B can be disposed opposite one another on the first end 14 of the rod 12. In other embodiments, the hooks 18A, 18B can be disposed on the rod 12 such that the angle formed between the two hooks 18A, 18B may be at an angle other than approximately 180°.

FIG. 2B shows an alternate configuration of a yard stake 210. In other embodiments, the first end 14 can be any structure configurable to dispose any object configured for use with a yard stake 10. This can be a structure configured to uphold accessories including, for example, lights or speakers. In some examples, this can be a generally U-shaped structure 218 used to position an accessory therein. The U-shaped structure 218 can include two upwardly-oriented arms 220A, 220B forming a channel 222. An object (not pictured) can be disposed within the channel 222, the two arms 220A, 220B maintaining the position of an object within the channel 222. The width of the channel can range from about 0.5″ to about 24″. The yard stake 10 can be used in combination with a plurality of additional yard stakes to uphold larger and/or longer accessories.

FIG. 2C shows another alternative configuration of the yard stake 240. Some embodiments of the yard stake 240 can include a curved structure 242. The curved structure 242 can be the first end 14 of the rod 12. The metal coil 242 can include a plurality of coils 244A, 244B, 244C, 244D. Each coil 244 can be width apart from an adjacent coil 244. In some instances, the width between each coil 244 and its adjacent coil 244 can be a different width. For example, the width between the coils 244 with each coil of the curved structure 242. That is, there can be a first width 246A between a coil 244A and its adjacent coil 244B. There can be a second width 246B between a coil 244B and its adjacent coil 244C. The first width 246A can be less than the second width 246B. There can be a third width 246C between a coil 244C and its adjacent coil 244D. The third width 246C can be greater than the first width 246A and the second width 246B.

FIG. 2D is a close-up view of the hook 18 of the yard stake 10 of FIG. 1. The hook 18 can be a generally curved structure. When the yard stake 10 is in use, the hook 18 can be at a greater height than the stopper 20A. The hook can be disposed at a distance away from the rod 12. The distance between the hook 18 and the rod 12 can be to accommodate objects of varying size being hung on the hook 18. In some embodiments, the hook can be about 11 inches from the rod 12.

The first and second protruding structures 20A, 20B can include a variety of features. For example, the protruding structures 20A, 20B can be disposed on the rod 12. In some embodiments, the protruding structures 20A, 20B can be welded onto or otherwise formed into the rod 12. The protruding structures 20A, 20B can be made of the same material as the rod 12, or be made of a different material. The protruding structures 20A, 20B can be washers. In some embodiments, the material can be steel, copper, PVC, or wood. In some embodiments, the wood can be bamboo. The material of the yard stake 10 can be selected for aesthetic purposes. The first protrusion 20A can be an upper protrusion. The second protrusion 20B can be a lower protrusion. The first and second protrusion 20A, 20B can protrude a length from the rod 12 greater than the diameter of the driver 14. In some embodiments, the first and second protrusions 20A, 20B can protrude a length of about ¼″ to about 2″. In other embodiments, the first and second protrusions 20A, 20B can protrude a length of about ⅜″.

The yard stake 10 can include a base structure 24 at the second end of the rod 16. The base structure 24 can be any shape. In some examples, the base structure 24 can be a trapezoid. The base structure 24 can have a thickness of about 1/16^{th}″ to about ¼^{th}″. In some embodiments, the base structure 24 can include a sharp edge 25 to facilitate movement of the base structure 24 in use. In such embodiments, the thickness of the base structure can range from about 1/16″ to about 1″. The base structure 24 can be a spade. The base structure can have a height of about 2″ and a width of about 9″. In other embodiments, the height of the base structure can be about 1″ to about 6″ and the width of the base structure can be about 2″ to about 12″. The base structure 24 can provide stability to the yard stake 10 when the yard stake 10 is inserted into the ground up to the location of base structure 24. This can prevent movement by the yard stake 10 in response to external forces, such as animals and/or weather that can cause movement of the yard stake 10. Stabilizing the yard stake can prevent damage to the accessories disposed thereon.

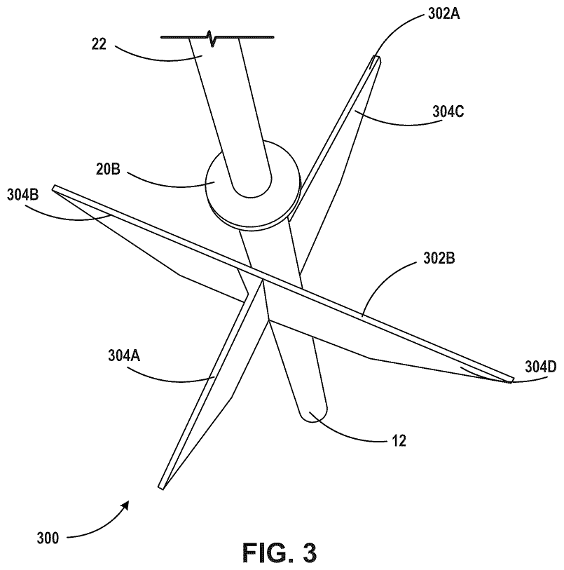

FIG. 3 shows an alternate embodiment 300 including a base structure 302. The base structure 302 can include four blades 304A, 304B, 304C, 304D. The base structure 302 can be two spades 302A, 302B forming the four blades 304A, 304B, 304C, 304D. When the base structure 302 includes two spades 302A, 302B, the two spades 302A, 302B can intersect one another. This intersection can form approximately 90-degree angles between the spades. The rod 12 can be positioned at the intersection of the two spades 302A, 302B. The two spades 302A, 302B can be attached to the rod 12 in a variety of ways. In some examples, the two spades 302A, 302B can be welded to the rod 12. When the yard spade 300 includes a coil (such as the curved structure 242 of FIG. 2C), the base structure 302 can include a four-blade configuration. Such a configuration provides additional stability and support for the yard stake 300.

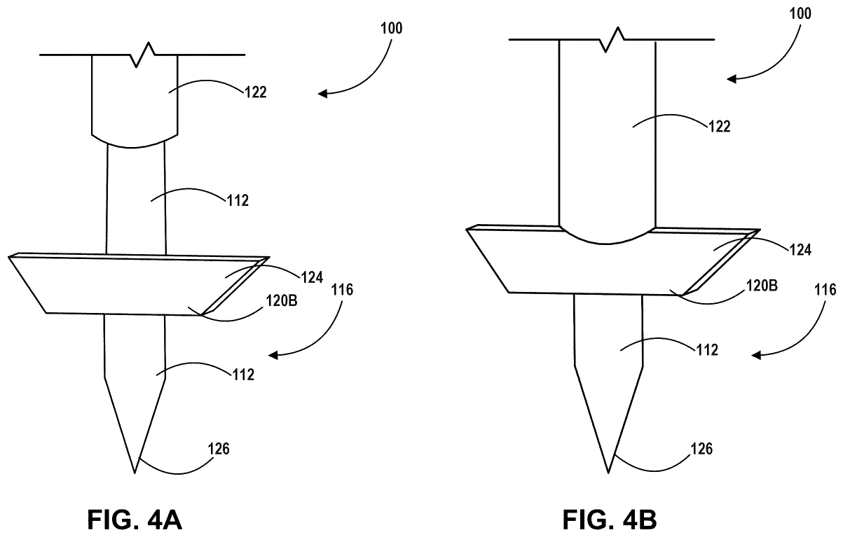

FIGS. 4A and 4B show another embodiment 100 of the base structure 124. In some examples, the base structure 124 can be the second protrusion 120B. When the base structure 124 is the second protrusion 120B, the driver 122 can come into contact with the base structure 124 during use, as is discussed in further detail below.

The second end 116 of the rod 112 can be below the base structure 124. The second end of the rod 116 can have a pointed end 126 to assist in the insertion of the yard stake 100 into the ground. The base structure 124 can be about 4″ to about 14″ from the pointed tip 126. In other embodiments, the base structure 124 can be 14″ from the pointed tip 126. The distance from the base structure 124 to the pointed tip 126 can be determined using the total length of the device 10. The greater the length of the device 10, the further away the base structure 124 can be from the pointed tip 126.

In use, a user can manipulate the driver 122 by moving the driver 122 between the first (not pictured) and second protruding structures 120B, as shown in FIGS. 3A and 3B. When the yard stake 100 is being installed in the ground, this can require that a user manipulate the driver 122 by applying a downward force onto the second or lower protrusion 120B. This can require that a user raise the driver 122, then lower the driver 122 such that it makes contact with and/or strikes the second protrusion 120B, thereby applying the downward force. This pushes the second or bottom end 116 of the rod 112 into the ground. By transferring the force to the protrusion 120B, the user does not have to exert the same quantity of force on the rod 112 directly to insert it into the ground.

Further, the downward force on the second protrusion 120B (or lower protrusion 20B of FIG. 1) can assist the insertion of the stabilizing base 124 into the ground. The width of the base structure 124 allows the base structure 124 to be inserted in a larger area, which prevents movement of the yard stake 110.

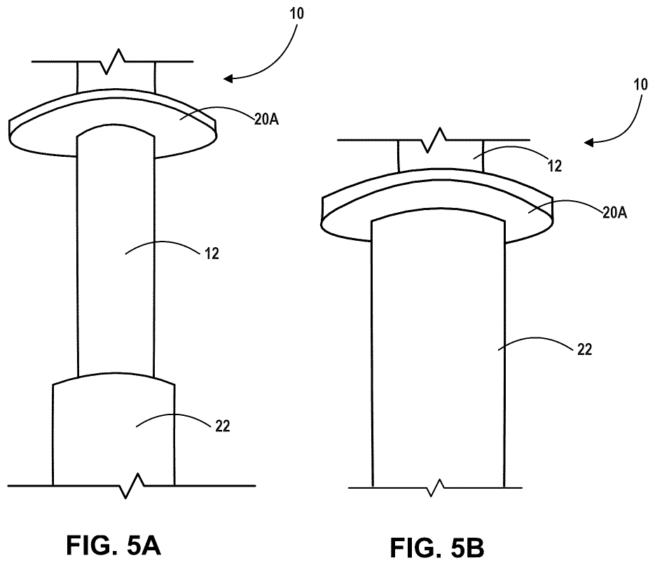

The driver 22 can be configured for other uses, as shown in FIGS. 5A and 5B. In some examples, the driver 22 can be used to remove the yard stake 10 from the ground. To remove the yard stake 10 from the ground, a user can manipulate the driver 22 such that the driver 22 exerts an upward force on the first protrusion 20A. This force can assist a user in removing the yard stake 10 from the ground by requiring less exertion by the user during use than if the user were to pull the yard stake 10 from the ground.

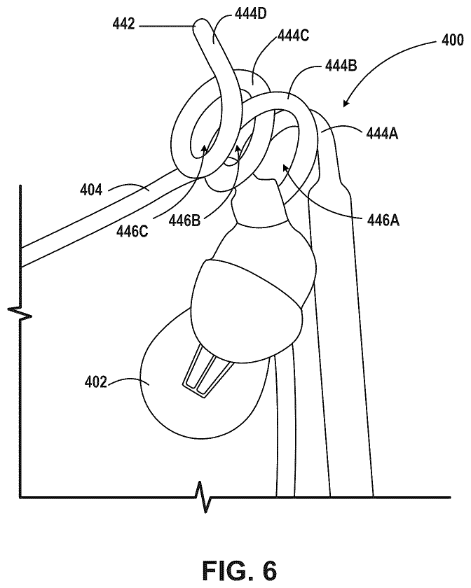

FIG. 6 shows a yard stake 400 in use. The yard stake 400 can be used to position a light 402. The light 402 can be positioned by orienting the light cord 404 within the curved structure 442. The light cord 404 can be positioned in the space 446A, 446B, 446C between the coils 444A, 444B, 444C, 444D of the curved structure 442. The light cord 404 can be positioned in such a space 446C at a location where two coils 444C, 444D maintain a position of the light cord 404.

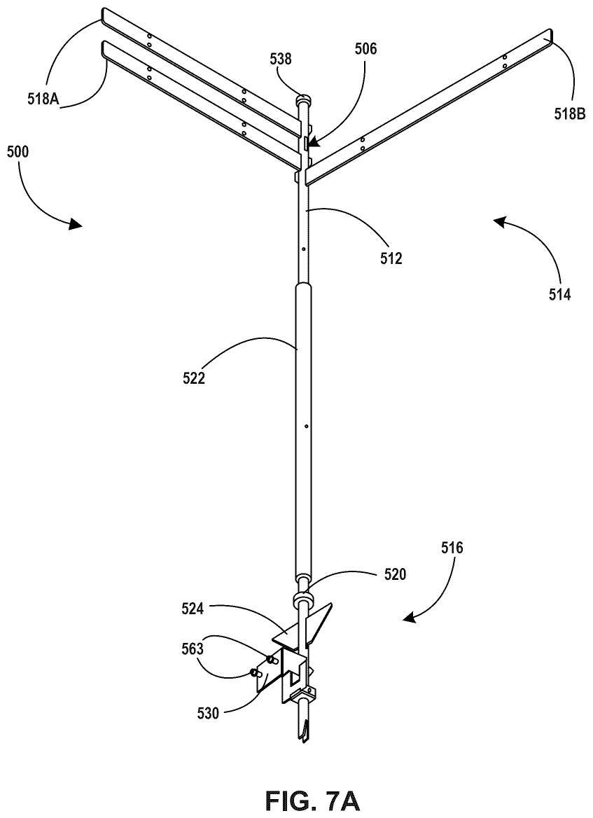

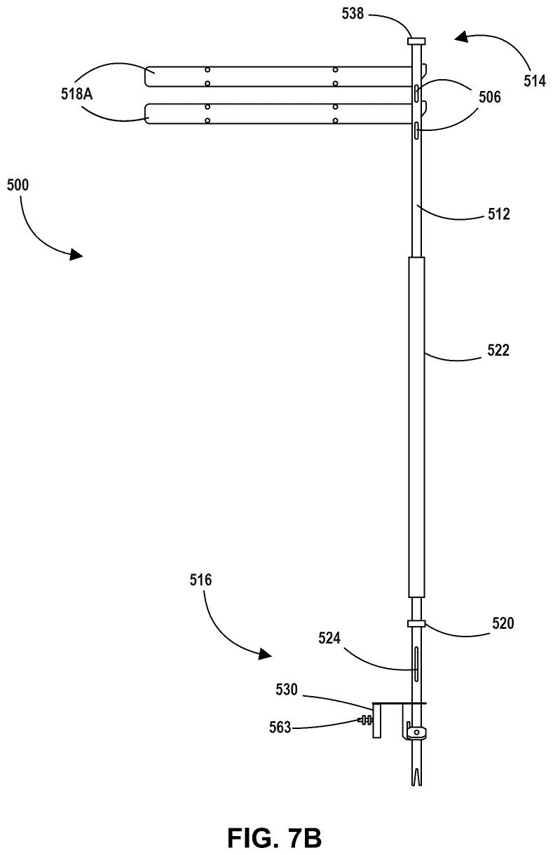

FIG. 7A and FIG. 7B (collectively discussed herein) each show an embodiment 500 of the yard stake having a signpost. The signpost 500 can have a rod 512 having a first end 514 and second end 516, a driver 522, and at least one protruding structure 520 (also referred to herein as a stopper). The first end 514 of the signpost 500 can have at least one slot 506 configured to receive a signpost panel 518A, 518B. A cap 538 can be inserted into the signpost rod 512. The second end 516 of the signpost 500 can have a spade 524 and/or mounting bracket 530. The driver 522 can be used to position the signpost 500 in a surface (such as the ground.) Similar to the yard stakes described above, a user can use the driver 522 to apply a force to the stopper 520, which can facilitate insertion of the signpost 500 into the ground.

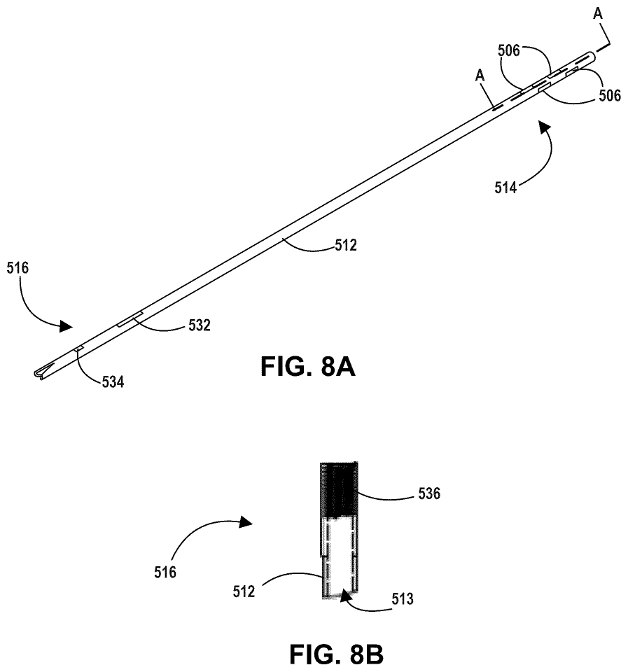

FIG. 8A shows a rod 512 of a signpost 500 having a first end 514 and a second end 516. The first end 514 can include at least one slot 506 configured to receive a panel 518A, 518B. The slots 506 can be radially disposed on the rod 512. Further, the slots 506 can be disposed at different heights from one another. This can allow multiple panels 518 to be placed adjacent one another. In some examples, a panel 518 may be positioned above another panel 518 when the signpost 500 is in use. Each slot 506 can extend through the rod 512 such that an object inserted into the slot 506 would pass through the rod 512.

The second end 516 can include a variety of features. For example, a plurality of openings 532, 534 can be disposed at the second end 516 of the rod. The openings 532, 534 can be configured to receive a variety of stabilizers. For example, a spade 524 can be inserted into an opening 532. Additionally or alternatively, a mounting bracket 530 can be attached at a fastener opening 534, as will be discussed in further detail below.

FIG. 8B shows a close-up view of cross section A-A of FIG. 8A. The rod 512 can have a hollow interior 513. The hollow interior 513 may include a threaded portion 536. The threaded portion 536 can receive a cap 538. Alternatively, the threaded portion 536 can receive any threaded connector attachable to the threaded portion 536. This can be used to attach other structures to the rod 512. The threaded portion can be about 1.25 inches to about 1.5 inches. In some embodiments, the hollow interior 513 can have a diameter of about 0.5 inches to about 0.75 inches. In other embodiments, the diameter of the hollow interior 513 can be about 0.62 inches. The rod 512 can be formed by a rod wall having a thickness of about 0.5 inches to about 1 inch. In other embodiments, the thickness can be about 0.84 inches.

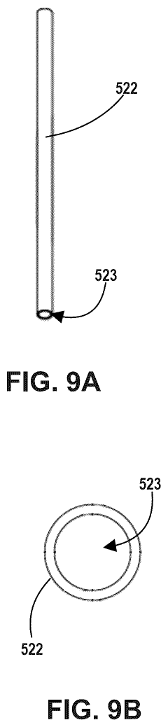

FIG. 9A and FIG. 9B each show the driver 522. The driver 522 can be a hollow rod with an interior cavity 523. The interior cavity 523 can be configured to receive the rod 512 such that the driver 523 is slidably disposed around the rod 512. In some embodiments, the diameter of the interior cavity 523 can be about 1.25 to about 1.5 inches. In other embodiments, the diameter of the interior cavity can be about 1.32 inches. The driver 522 can have a length ranging from about 2′ to about 5′. In some embodiments, the driver 522 can have a length of about 32 inches.

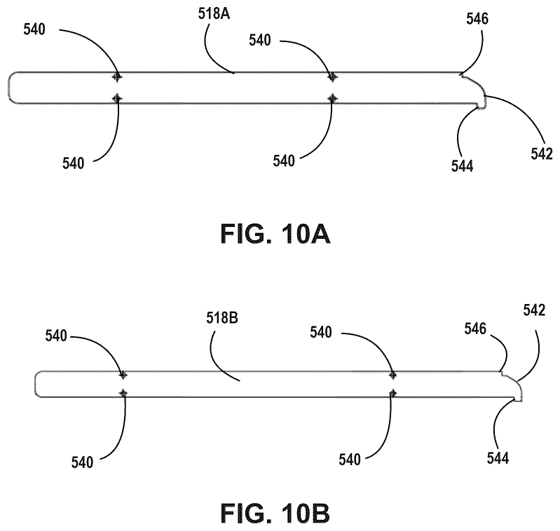

FIG. 10A and FIG. 10B each show different embodiments of panels 518. The panels 518 can range in size. For example, FIG. 10A shows panel 518A. The panel 518A can have a plurality of fastener openings 540. The fastener openings 540 can be used to mount additional components or structures to the panels 518. Similarly, the panel 518B of FIG. 10B can also have a plurality of fastener openings 540. The length of each panel can range from about 2 feet to about 4 feet. In some embodiments, signs may be mounted to panels 518.

Each panel 518A, 518B can have a fastener 542 configured to attach the panel 518A, 518B to the rod 512. The fastener 542 can be inserted into a slot 506. The fastener 542 can include a lip 544 configured to position the panel 518 within the slot 506. The lip 544 can prevent the panel 518 from moving through the rod 512. A panel stop surface 546 can prevent the panel from moving into the slot 506. The panel stop surface 546 can contact the rod 512 when the panel 518 is inserted into the slot 506, thereby preventing movement of the panel 518.

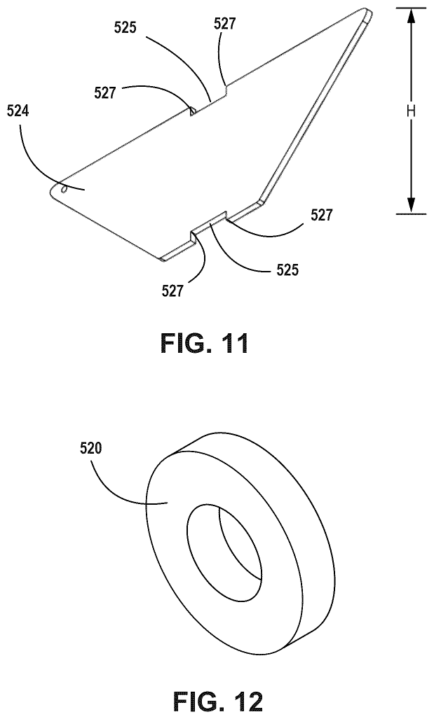

FIG. 11 shows a spade 524 of a signpost 500. The spade 524 can be configured to be positioned within the rod 512. The spade 524 can include a plurality of positioning channels 525. For example, when the spade 524 is inserted into the rod 512, the height of the slot 532 can be less than the height H of the spade 524. The positioning channels 525 can be disposed within the slot 532 such that the channel walls 528 extend beyond the height of the slot 532, thereby preventing translational movement of the spade 524.

FIG. 12 shows a washer 520. The washer 520 can act as a stopper 520 for the driver 522 during use. The washer 520 can be welded to the rod 512. In some embodiments, the washer 520 can be made of metal and can have an outer diameter of about 1.5 inches to about 3 inches. In other embodiments, the outer diameter can be about 1.83 inches. The outer diameter can be any diameter greater than the diameter of the driver 522. The inner diameter of the washer 520 can be the approximate diameter of the rod 512. In some embodiments, the inner diameter can range from about 0.5 inches to about 1 inch. In other embodiments, the inner diameter can be about 0.86 inches. While the embodiments herein show a circular washer, the stopper 520 can be any shape, thickness, or size configured to prevent movement of the driver 524 when in contact with the stopper 520.

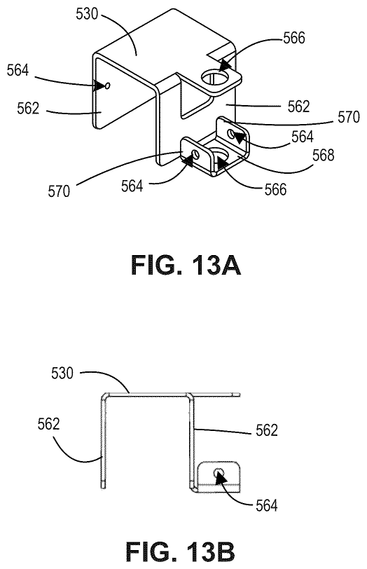

FIG. 13A-FIG. 13B each show a mounting bracket 530. The mounting bracket 530 can include a channel having two channel walls 562. A brick or other mounting structure (not pictured) may be positioned between the two walls 562. A stabilizing fastener 563 can be inserted into a fastener opening 564 located on at least one of the channel walls 562. The stabilizing fastener 563 can be inserted through the fastener opening 564 to prevent movement or displacement of the mounting bracket 530 relative to the mounting structure. A mounting bracket 530 can be used in conditions where it may not be favorable to insert a yard stake into the ground. For example, the mounting bracket 530 can be used during the winter, or in other conditions where the ground may be difficult to manipulate a yard stake into.

The mounting bracket 530 can be attached to the rod 512 at a plurality of openings 566. The plurality of openings 566 can be configured to extend from the mounting bracket 530 such that the mounting bracket 530 is adjacent to the rod 512 during use. The rod 512 can be slidably inserted through the plurality of openings 566. At least one of the openings 566 can be disposed on a rod positioning channel 568.

The rod positioning channel 568 can include a variety of features. The positioning of the rod 512 can be modified within the plurality of openings 566 at the rod positioning channel 568. For example, the channel 568 can include channel walls 570. The channel walls 570 can be generally parallel to the rod 512. Each channel wall 570 can include a stabilizer opening 564. The stabilizer openings 564 can be configured to receive a stabilizer 564. In some embodiments, the stabilizer 564 may be a screw or other mechanical fastener. The stabilizer 564 can be used to modify the position of the rod 512. In some embodiments, the rod 512 can be adjusted such that it is angled relative to the ground and/or mounting surface. In other embodiments, the rod 512 may be perpendicular to the ground and/or mounting surface.

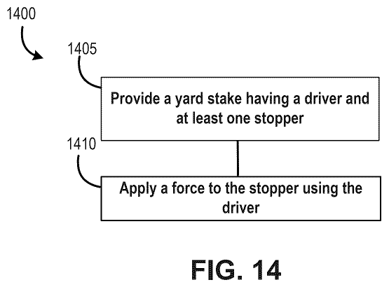

FIG. 14 shows a method 1400 of using a yard stake. The method can include providing a yard stake (block 1405) and applying a force to at least one of the first or second stopper by slidably moving the driver between the first stopper and second stopper such that the driver contacts at least one of the first and second stopper (block 1410).

The yard stake can include a rod, a first and second stopper, and a driver. The rod can have a first end and a second end. The first end can include a frame configured to receive an external object. The driver can be slidably disposed around the rod between the first stopper and the second stopper. The driver and rod can each have a length; the driver length can be less than the rod length.

In some embodiments, the yard stake can include a mount. Some embodiments of the method can include positioning the mount over a mounting surface.

The application of force to the stoppers can include a variety of applications. In some embodiments, applying a force to at least one of the first or second stopper by slidably moving the driver between the first stopper and second stopper such that the driver contacts at least one of the first and second stopper includes applying a greater force to the second stopper than to the first stopper, thereby positioning the yard stake at a location. Additionally or alternatively, in some embodiments of the method, the application of force can include applying a greater force to the first stopper than to the second stopper, thereby removing the yard stake at a location.

While the various systems described above are separate implementations, any of the individual components, mechanisms, or devices, and related features and functionality, within the various system embodiments described in detail above can be incorporated into any of the other system embodiments herein.

The term “about,” as used herein, refers to variation in the numerical quantity that can occur, for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The term “about” also encompasses these variations. The term “about” can include any variation of 5% or 10%, or any amount-including any integer-between 0% and 10%. Further, whether or not modified by the term “about,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Although the various embodiments have been described with reference to preferred implementations, persons skilled in the art will recognize that changes may be made in form and detail without departing from the spirit and scope thereof.

What is claimed is:

1. A yard stake, comprising:
(a) a rod comprising a first end and a second end opposite the first end, wherein the first end comprises a frame configured to receive an external object;
(b) a first stopper and a second stopper disposed on the rod;
(c) a driver slidably disposed around the rod between the first stopper and the second
stopper, the driver comprising a driver length; and wherein the rod comprises a rod length between the first and second stoppers and the driver
length is less than the rod length.

2. The yard stake of claim 1, wherein the second stopper comprises a base.

3. The yard stake of claim 2, wherein the base extends perpendicularly from the rod and is configured to stabilize the yard stake.

4. The yard stake of claim 1, wherein the driver comprises a slide hammer.

5. The yard stake of claim 1, wherein the frame comprises a hook.

6. The yard stake of claim 1, wherein the frame comprises a U-shaped structure.

7. The yard stake of claim 1, wherein the frame comprises two hooks.

8. The yard stake of claim 1, wherein the frame comprises a coil.

9. The yard stake of claim 1, further comprising a base configured to stabilize the yard stake, wherein the base is separate from the second stopper.

10. The yard stake of claim 9, wherein the base comprises a spade.

11. The yard stake of claim 1, wherein the second end of the rod comprises a pointed end.

12. The yard stake of claim 1, wherein the driver comprises one or more handles.

13. A yard stake, comprising:
(a) a rod comprising a first end and a second end opposite the first end, wherein the first end comprises a slot;
(b) a stopper disposed on the rod;
(c) a driver disposed below the stopper; and
(d) a stabilizer disposed at the second end of the rod,
wherein the driver is slidably disposed around the rod and between the stabilizer and the stopper.

14. The yard stake of claim 13, further comprising a hanging panel insertable into the slot.

15. The yard stake of claim 13, further comprising a mounting bracket.

16. The yard stake of claim 15, wherein the mounting bracket is configured to mount the yard stake to a brick.

17. A method of positioning a yard stake, comprising:
(a) providing a yard stake, the yard stake comprising:
(i) a rod comprising a first end and a second end opposite the first end, wherein the first end comprises a frame configured to receive an external object;
(ii) a first stopper and a second stopper disposed on the rod;
(iii) a driver slidably disposed around the rod between the first stopper and the second stopper, the driver comprising a driver length; and
wherein the rod comprises a rod length between the first and second stoppers and the driver
length is less than the rod length; and
(b) applying a force to at least one of the first or second stopper by slidably moving the driver between the first stopper and second stopper such that the driver contacts at least one of the first and second stopper.

18. The method of claim 17, wherein the yard stake comprises a mount, and wherein the method further comprises positioning the mount over a mounting surface.

19. The method of claim 17, wherein applying a force to at least one of the first or second stopper by slidably moving the driver between the first stopper and second stopper such that the driver contacts at least one of the first and second stopper comprises applying a greater force to the second stopper than to the first stopper, thereby positioning the yard stake at a location.

20. The method of claim 17, wherein applying a force to at least one of the first or second stopper by slidably moving the driver between the first stopper and second stopper such that the driver contacts at least one of the first and second stopper comprises applying a greater force to the first stopper than to the second stopper, thereby removing the yard stake at a location.
